(19) United States
(12) Patent Application Publication
(10) Pub. No.: US 2019/0329392 A1
(43) Pub. Date: Oct. 31, 2019

(54) BUSHING FOR HYDRAULIC BREAKER AND METHOD FOR PRODUCING THE SAME

(71) Applicant: KOMATSU LTD., Tokyo (JP)

(72) Inventors: Eiji AMADA, Tokyo (JP); Tetsushi OKADA, Tokyo (JP); Yoichi TAKAGI, Tokyo (JP); Yusuke KONDO, Tokyo (JP)

(73) Assignee: KOMATSU LTD., Tokyo (JP)

(21) Appl. No.: 16/098,420

(22) PCT Filed: Mar. 15, 2017
(86) PCT No.: PCT/JP2017/010529

§ 371 Date: Nov. 1, 2018

(30) Foreign Application Priority Data
May 26, 2016 (JP) 2016-105200

(51) Int. Cl. B25D 17/08; F16C 29/02; C22C 38/44; C22C 38/04; C22C 38/02; C22C 38/00; C21D 9/00; C21D 6/00; C21D 1/18

(52) U.S. Cl. CPC B25D 17/08; C21D 2221/00; C22C 38/44; C22C 38/04; C22C 38/02; C22C 38/002; C21D 9/0068; C21D 6/008; C21D 6/005; C21D 6/004; C21D 1/18; B25D 2222/72; B25D 2250/125; B25D 2250/365; F16C 2204/26; F16C 2204/64; F16C 2204/62; F16C 2204/70; F16C 2223/10; F16C 29/02

(57) ABSTRACT

An inner-flanged bushing for a hydraulic breaker is a tubular shape having an inner flange and is made of a steel containing at least 0.55% and less than 0.70% by mass of carbon, at least 0.15% and less than 0.35% by mass of silicon, at least 0.4% and less than 0.9% by mass of manganese, at least 0.4% and less than 1.3% by mass of chromium, and at least 0.10% and less than 0.55% by mass of molybdenum, with the balance being iron and unavoidable impurities. The bushing includes a base region having a hardness of at least 30 HRC and less than 45 HRC, and a quench hardened layer formed on an inner periphery side of the base region to include an inner peripheral surface of a region including the inner flange, the quench hardened layer having a hardness of at least 55 HRC and less than 63 HRC.

### TECHNICAL FIELD

The present invention relates to a bushing for a hydraulic breaker and a method for producing the bushing.

### BACKGROUND ART

A hydraulic breaker, attached to a distal end of an arm of a work machine, is used for crushing rocks, concretes, furnace walls, steelmaking slag, and so on. The hydraulic breaker has a rod-shaped chisel, which is axially driven by a piston to crush rocks or the like. The chisel is held in a state where its proximal end side is surrounded by a frame and its distal end side protrudes from the frame. The hydraulic breaker is used, not only in the posture where the chisel strikes rocks or the like vertically downward, but also in the posture where the chisel is driven horizontally, and even in the posture where the chisel strikes rocks or the like vertically upward. This allows sand and other materials to enter in between the chisel and the frame, possibly leading to considerable wear of the frame. The frame therefore requires wear resistance in the region coming into contact with the chisel.

As the frame wears away, the distance between the chisel and the frame increases, resulting in collision between the chisel and the frame during operation. The frame therefore requires toughness in the region coming into contact with the chisel. From the standpoint of addressing such requirements, the region of the frame coming into contact with the chisel is provided with a bushing which is of a tubular shape surrounding an outer peripheral surface of the chisel. For the material constituting the bushing, a quenched and tempered alloy steel for machine structural use (for example, JIS SCM435, SCM440, SNCM439, etc.) may be adopted. Further, it has been proposed to adopt a nitriding steel, which is excellent in toughness, as the material constituting the bushing (see, for example, Japanese Patent Application Laid-Open No. H8-193242 (Patent Literature 1)).

### CITATION LIST

### Patent Literature

Patent Literature 1: Japanese Patent Application Laid-Open No. H8-193242

### SUMMARY OF INVENTION

### Technical Problem

In the case of adopting a quenched and tempered alloy steel for machine structural use as the material constituting a bushing, however, if the hardness of the bushing is adjusted to a level assuring sufficient wear resistance, the toughness of the bushing will become insufficient. In the case of adopting a nitriding steel as in Patent Literature 1 above, although high surface hardness may be achieved while ensuring sufficient toughness, the nitrided layer as the hardened layer may have an insufficient thickness, with which it will be difficult to achieve sufficient wear resistance.

The present invention has been made to address the above problems, with an object of providing a bushing for a hydraulic breaker that offers both wear resistance and toughness and a method for producing the bushing.

### Solution to Problem

A bushing for a hydraulic breaker according to the present invention is of a tubular shape having an inner flange protruding radially toward a center from an inner periphery in a region including an axial end, and is made of a steel containing not less than 0.55% by mass and not more than 0.70% by mass of carbon (C), not less than 0.15% by mass and not more than 0.35% by mass of silicon (Si), not less than 0.4% by mass and not more than 0.9% by mass of manganese (Mn), not less than 0.4% by mass and not more than 1.3% by mass of chromium (Cr), and not less than 0.15% by mass and not more than 0.50% by mass of molybdenum (Mo), with the balance being iron (Fe) and unavoidable impurities. The bushing for a hydraulic breaker includes: a base region having a hardness of not less than 30 HRC and not more than 45 HRC; and a quench hardened layer formed on an inner periphery side of the base region so as to include an inner peripheral surface of a region including the inner flange, the quench hardened layer having a hardness of not less than 55 HRC and not more than 63 HRC.

The bushing for a hydraulic breaker in the present invention is of a tubular shape having the inner flange. The inner flange receives impacts from the chisel, so it requires particularly superior wear resistance and toughness. The inventive bushing for a hydraulic breaker is made of the steel having the above-described appropriate component composition. The quench hardened layer having a hardness of not less than 55 HRC and not more than 63 HRC, formed to include the inner peripheral surface of the region including the inner flange coming into contact with the chisel, ensures high wear resistance. Further, the base region as the region where no quench hardened layer is formed, having a hardness of not less than 30 HRC and not more than 45 HRC, imparts high toughness. Thus, according to the bushing for a hydraulic breaker of the present invention, it is possible to provide the bushing for a hydraulic breaker that offers both wear resistance and toughness.

In the bushing for a hydraulic breaker described above, among the unavoidable impurities in the steel, phosphorus (P) and sulfur (S) are preferably contained in an amount of not more than 0.015% by mass, respectively. Phosphorus and sulfur are impurities that degrade toughness of the steel. Therefore, by restricting their content to 0.015% by mass or less, it is possible to more reliably improve the toughness of the bushing for a hydraulic breaker in the present invention.

In the bushing for a hydraulic breaker described above, the quench hardened layer may have a thickness of not less than 3 mm and not more than 8 mm. Sufficient wear resistance can be obtained more reliably with the quench hardened layer having the thickness of 3 mm or more. On the other hand, sufficient toughness can be obtained more reliably with the quench hardened layer having the thickness of 8 mm or less.

In the bushing for a hydraulic breaker described above, the quench hardened layer may have a thickness that takes up not less than 10% and not more than 40% of a total thickness in a region corresponding to the inner flange. Sufficient wear resistance can be obtained more reliably with the quench hardened layer having the thickness that takes up not less than 10% of the total thickness. On the other hand, sufficient toughness can be obtained more reliably with the quench hardened layer having the thickness that takes up not more than 40% of the total thickness.

In the bushing for a hydraulic breaker described above, a region corresponding to the inner flange may have an inner peripheral surface included in the quench hardened layer and an outer peripheral surface included in the base region. With this configuration, it is possible to obtain high toughness with the base region disposed on the outer peripheral surface side, while ensuring wear resistance with the quench hardened layer disposed on the inner peripheral surface of the inner flange to which wear resistance is essential.

In the bushing for a hydraulic breaker described above, an end face on a side where the inner flange is located may include the quench hardened layer on an inner peripheral surface side and the base region on an outer peripheral surface side. With this configuration, it is possible to obtain high toughness with the base region disposed on the outer peripheral surface side, while ensuring wear resistance with the quench hardened layer disposed on the inner peripheral surface side of the inner flange to which wear resistance is essential.

A method for producing a bushing for a hydraulic breaker according to the present invention includes the steps of: preparing a formed body of a tubular shape having an inner flange protruding radially toward a center from an inner periphery in a region including an axial end, the formed body being made of a steel containing not less than 0.55% by mass and not more than 0.70% by mass of carbon, not less than 0.15% by mass and not more than 0.35% by mass of silicon, not less than 0.4% by mass and not more than 0.9% by mass of manganese, not less than 0.4% by mass and not more than 1.3% by mass of chromium, and not less than 0.15% by mass and not more than 0.50% by mass of molybdenum, with the balance being iron and unavoidable impurities, the formed body having a hardness of not less than 30 HRC and not more than 45 HRC; and forming a quench hardened layer by performing induction hardening processing on a region including an inner peripheral surface of a region including the inner flange of the formed body, the quench hardened layer having a hardness of not less than 55 HRC and not more than 63 HRC.

According to the method for producing the bushing for a hydraulic breaker in the present invention, the formed body is prepared which is made of the steel having the above-described appropriate component composition, has a shape corresponding to the bushing for a hydraulic breaker having the inner flange, and has a hardness of not less than 30 HRC and not more than 45 HRC. Thereafter, induction hardening processing is performed on the region including the inner peripheral surface of the region including the inner flange, whereby the quench hardened layer having a hardness of not less than 55 HRC and not more than 63 HRC is formed. In this manner, it is possible to readily produce the bushing for a hydraulic breaker of the present invention.

In the method for producing the bushing for a hydraulic breaker described above, it is preferable that phosphorus and sulfur among the unavoidable impurities in the steel are contained respectively in an amount of not more than 0.015% by mass. By restricting the content of phosphorus and sulfur as the impurities degrading toughness to 0.015% by mass or less, it is possible to more reliably improve the toughness of the bushing for a hydraulic breaker.

In the step of forming the quench hardened layer, the quench hardened layer may be formed to have a thickness of not less than 3 mm and not more than 8 mm. Sufficient wear resistance can be obtained more reliably with the quench hardened layer having the thickness of 3 mm or more. On the other hand, sufficient toughness can be obtained more reliably with the quench hardened layer having the thickness of 8 mm or less.

In the step of forming the quench hardened layer, the quench hardened layer may be formed so as to have a thickness that takes up not less than 10% and not more than 40% of a total thickness in a region corresponding to the inner flange. Sufficient wear resistance can be obtained more reliably with the quench hardened layer having the thickness that takes up not less than 10% of the total thickness. On the other hand, sufficient toughness can be obtained more reliably with the quench hardened layer having the thickness that takes up not more than 40% of the total thickness.

In the method for producing the bushing for a hydraulic breaker described above, in the step of forming the quench hardened layer, the quench hardened layer may be formed in such a manner that an interface between the quench hardened layer and a base region as a region other than the quench hardened layer is located between an inner peripheral surface and an outer peripheral surface of a region corresponding to the inner flange. With this configuration, it is possible to obtain high toughness with the base region disposed on the outer peripheral surface side, while ensuring wear resistance with the quench hardened layer disposed to include the inner peripheral surface of the inner flange to which wear resistance is essential.

Here, a description will be made about the reasons why the component composition of the steel is limited to the above-described range.

Carbon: Not Less than 0.55% by Mass and not More than 0.70% by Mass

Carbon greatly affects the hardness of the quench hardened layer. From the standpoint of securing a hardness of not less than 58 HRC which is the hardness necessary for wear resistance in the case of performing tempering at 180° C. which is the tempering temperature necessary for securing toughness of the base region, the carbon content needs to be 0.55% by mass or more. On the other hand, the increase of the hardness saturates when the carbon content exceeds 0.70% by mass. The carbon content is therefore set to be 0.70% by mass or less and preferably 0.65% by mass or less.

Silicon: Not Less than 0.15% by Mass and not More than 0.35% by Mass

Silicon is an element which is effective in improving the hardenability of the steel and which also has a deoxidizing effect in the steelmaking process. If the silicon content is less than 0.15% by mass, the above effects cannot be obtained sufficiently. The silicon content therefore needs to be 0.15% by mass or more, and it is preferably 0.20% by mass or more. On the other hand, for obtaining the above effects, the silicon content exceeding 0.35% by mass is unnecessary.

Manganese: Not Less than 0.4% by Mass and not More than 0.9% by Mass

Manganese is an element which is effective in improving the hardenability of the steel and which also has a deoxidizing effect in the steelmaking process. If the manganese content is less than 0.4% by mass, the above effects cannot be obtained sufficiently. The manganese content therefore needs to be 0.4% by mass or more, and it is preferably 0.5% by mass or more. On the other hand, if the added amount of manganese exceeds 0.9% by mass, quenching crack may occur. The manganese content therefore needs to be 0.9% by mass or less, and it is preferably 0.8% by mass or less.

Chromium: not less than 0.4% by mass and not more than 1.3% by mass

Chromium improves hardenability of the steel. From the standpoint of securing sufficient hardenability, the chromium content needs to be 0.4% by mass or more, and it is preferably 0.45% by mass or more. On the other hand, if chromium is added excessively, quenching crack may occur. From the standpoint of preventing occurrence of quenching crack, the chromium content needs to be 1.3% by mass or less, and it is preferably 1.2% by mass or less.

Molybdenum: Not Less than 0.10% by Mass and not More than 0.55% by Mass

Molybdenum improves hardenability and enhances the resistance to temper softening. Molybdenum also contributes to improved toughness. If the molybdenum content is less than 0.10% by mass, the above effects cannot be exerted sufficiently. The molybdenum content therefore needs to be 0.10% by mass or more, and it is preferably 0.15% by mass or more. On the other hand, if the molybdenum content exceeds 0.55% by mass, the above effects will be saturated. The molybdenum content is therefore made to fall within the above-described range. The molybdenum content of 0.50% by mass or less can reduce the production cost of the steel.

### Effects of Invention

As is clear from the above description, according to the bushing for a hydraulic breaker and the method for producing the bushing in the present invention, it is possible to provide the bushing for a hydraulic breaker that offers both wear resistance and toughness, and the method for producing the bushing.

### BRIEF DESCRIPTION OF DRAWINGS

FIG. 1 is a schematic cross-sectional view showing a structure of a hydraulic breaker;

FIG. 2 is a schematic cross-sectional view showing a structure of an inner-flanged bushing;

FIG. 3 is a flowchart schematically illustrating steps of producing the inner-flanged bushing;

FIG. 4 is a schematic cross-sectional view illustrating a method for producing the inner-flanged bushing;

FIG. 5 is a schematic cross-sectional view illustrating the induction hardening step; and

FIG. 6 is a diagram showing a relationship between a hardness and a distance from an inner peripheral surface for respective samples.

### DESCRIPTION OF EMBODIMENT

An embodiment of the present invention will be described below. In the following drawings, the same or corresponding parts are denoted by the same reference numerals, and the description thereof will not be repeated.

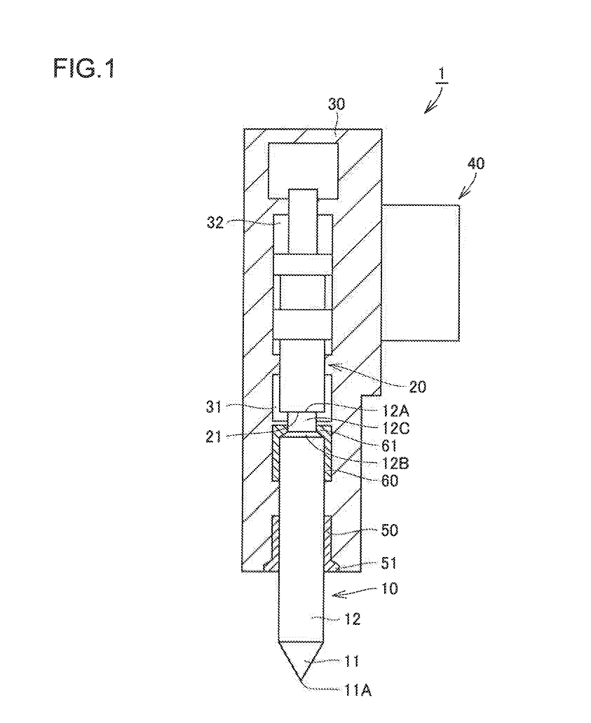

FIG. 1 is a schematic cross-sectional view showing a structure of a hydraulic breaker. Referring to FIG. 1, a hydraulic breaker 1 in the present embodiment includes a chisel 10, a piston 20, and a frame 30.

The chisel 10 has a rod shape. The chisel 10 includes a base portion 12, a distal narrowing portion 11, a proximal narrowing portion 12B, and a proximal cylindrical portion 12C. The base portion 12 has a cylindrical shape. The distal narrowing portion 11 is connected to an end of the base portion 12, and has a conical shape with its cross sectional area perpendicular to the axial direction decreasing with decreasing distance to a distal end 11A. The proximal narrowing portion 12B is connected to the other end of the base portion 12, and has a frustoconical shape with its cross sectional area perpendicular to the axial direction decreasing with decreasing distance to a proximal end 12A. The proximal cylindrical portion 12C is connected to one side of the proximal narrowing portion 12B opposite to the side connected to the base portion 12, and has a cylindrical shape. The proximal end 12A corresponds to an end face of the proximal cylindrical portion 12C opposite to the proximal narrowing portion 12B side. The chisel 10 axially has one side close to the proximal end 12A surrounded by the frame 30, and the other side close to the distal end 11A protruding from the frame 30.

The piston 20 has a rod shape. The piston 20 is disposed in a region surrounded by the frame 30. The piston 20 is disposed coaxially with the chisel 10. The piston 20 has, on its distal end, a distal flat portion 21 which is a flat portion intersecting the axial direction. The chisel 10 and the piston 20 are arranged in such a manner that the distal flat portion 21 of the piston 20 faces the proximal end 12A of the chisel. The piston 20 is held to be axially movable relative to the frame 30.

As the piston 20 moves in the axial direction to hit the chisel 10, impact force is transmitted to the chisel 10. In an impact chamber 31 formed on the inner periphery side of the frame 30, the distal flat portion 21 of the piston 20 makes contact with the proximal end 12A of the chisel 10, so that the impact force is transmitted from the piston 20 to the chisel 10. The chisel 10 uses the transmitted impact force to crush rocks or the like.

An oil chamber 32 is formed between the piston 20 and the frame 30 where hydraulic oil for driving the piston 20 is received. A control valve mechanism 40 is disposed on a side surface of the frame 30. As the hydraulic oil is supplied from the control valve mechanism 40 to the oil chamber 32, the piston 20 is driven in the axial direction to strike the chisel 10. The chisel 10 crushes rocks or the like by the impact force transmitted from the piston 20.

On the inner wall surface of the frame 30, a region coming into contact with the chisel 10 in the above-described operation is required to have wear resistance. In particular, the region of the frame 30 surrounding the proximal narrowing portion 12B of the chisel 10 and the region near the opening of the frame 30 are required to have particularly high wear resistance. These regions are therefore provided with an inner-flanged bushing 60 and an outer-flanged bushing 50, respectively. The inner-flanged bushing 60 and the outer-flanged bushing 50 each have a hollow cylindrical shape. The inner-flanged bushing 60 and the outer-flanged bushing 50 are press-fitted inside the frame 30, for example.

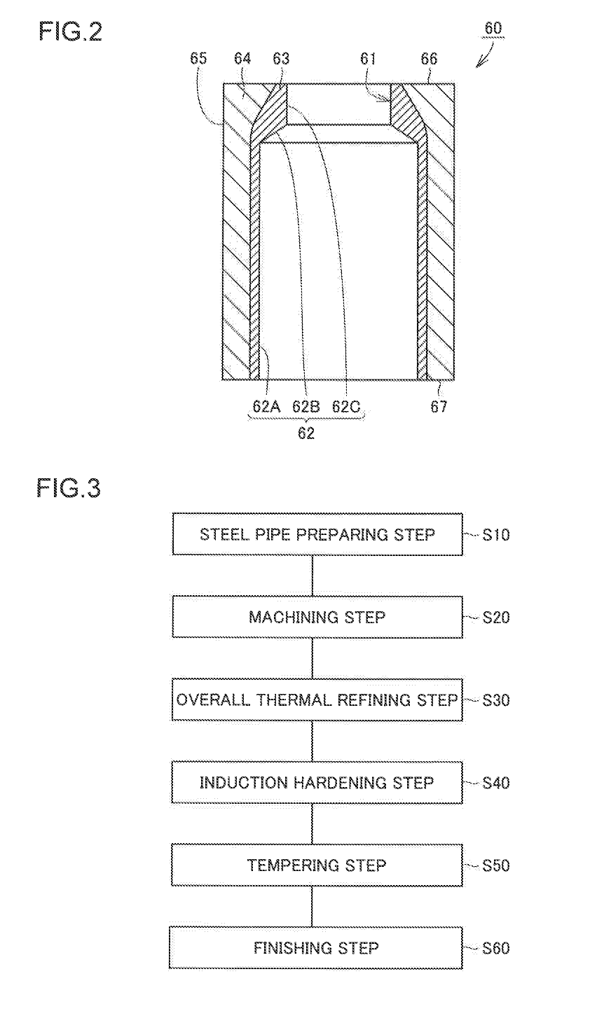

The inner-flanged bushing 60, which is the busing for a hydraulic breaker in the present embodiment, will now be described with reference to FIGS. 1 and 2. FIG. 2 is a schematic cross-sectional view showing a structure of an inner-flanged bushing. Referring to FIG. 2, the inner-flanged bushing 60 is of a tubular shape with an inner flange 61 provided on an inner periphery of a region including an axial end to protrude radially toward a center (toward the central axis). The inner-flanged bushing 60 has an inner peripheral surface 62 which includes: a large-diameter portion 62A having a cylindrical surface shape; a tapered portion 62B connected to the large-diameter portion 62A and having a conical surface shape with its diameter decreasing with increasing distance from the large-diameter portion 62A; and a small-diameter portion 62C connected to a side of the tapered portion 62B opposite to the large-diameter portion 62A and having a cylindrical surface shape with its diameter smaller than that of the large-diameter portion 62A.

The inner-flanged bushing 60 is made of a steel (steel for bushing) that contains not less than 0.55% by mass and not more than 0.70% by mass of carbon, not less than 0.15% by mass and not more than 0.35% by mass of silicon, not less than 0.4% by mass and not more than 0.9% by mass of manganese, not less than 0.4% by mass and not more than 1.3% by mass of chromium, and not less than 0.10% by mass and not more than 0.55% by mass of molybdenum, with the balance being iron and unavoidable impurities. Phosphorus and sulfur, included in the unavoidable impurities, are preferably contained in an amount of not more than 0.015% by mass, respectively.

The inner-flanged bushing 60 includes a base region 64 and a quench hardened layer 63. The base region 64 has a cylindrical shape, and has a hardness of not less than 30 HRC and not more than 45 HRC. The steel constituting the base region 64 has a tempered martensitic structure. The quench hardened layer 63 is formed on an inner periphery side of the base region 64 so as to include the inner peripheral surface 62 (tapered portion 62B and small-diameter portion 62C) of a region including the inner flange 61, and has a hardness of not less than 55 HRC and not more than 63 HRC. The quench hardened layer 63 has a thickness of not less than 3 mm and not more than 8 mm, for example. In the region corresponding to the inner flange 61, the thickness of the quench hardened layer 63 takes up, for example, not less than 10% and not more than 40% of the total thickness. The region corresponding to the inner flange 61 has its inner peripheral surface 62 (tapered portion 62B and small-diameter portion 62C) included in the quench hardened layer 63, and has its outer peripheral surface 65 included in the base region 64. In the present embodiment, the quench hardened layer 63 is formed over the entirety of the inner peripheral surface 62. One end face 66 of the bushing on the side where the inner flange 61 is located includes the quench hardened layer 63 on the inner peripheral surface 62 side and the base region 64 on the outer peripheral surface 65 side. The one end face 66 and the other end face 67 in the axial direction of the inner-flanged bushing 60 each have the base region 64 as a non-hardened layer and the quench hardened layer 63 formed on the outer periphery side and the inner periphery side, respectively.

The inner-flanged bushing 60 in the present embodiment is of a tubular shape having the inner flange 61. The inner flange 61 is struck with the proximal narrowing portion 12B and the proximal cylindrical portion 12C of the chisel 10, so it requires particularly superior wear resistance and toughness. The inner-flanged bushing 60 is made of the steel having the above-described appropriate component composition. The quench hardened layer 63 having a hardness of not less than 55 HRC and not more than 63 HRC, formed to include the inner peripheral surface 62 of the region including the inner flange 61 that comes into contact with the chisel 10, ensures high wear resistance. Further, the base region 64 as the region where no quench hardened layer 63 is formed, having a hardness of not less than 30 HRC and not more than 45 HRC, imparts high toughness. Thus, the inner-flanged bushing 60 which is the bushing for a hydraulic breaker in the present embodiment implements the bushing for a hydraulic breaker that offers both wear resistance and toughness.

A description will now be made about an exemplary method for producing an inner-flanged bushing 60 in the present embodiment. FIG. 3 is a flowchart schematically illustrating a method for producing an inner-flanged bushing 60. Referring to FIG. 3, in the method for producing the inner-flanged bushing 60 in the present embodiment, firstly, a steel pipe preparing step is carried out as a step S10. In this step S10, a steel pipe made, for example, of the above-described steel for bushing and having a hollow cylindrical shape is prepared.

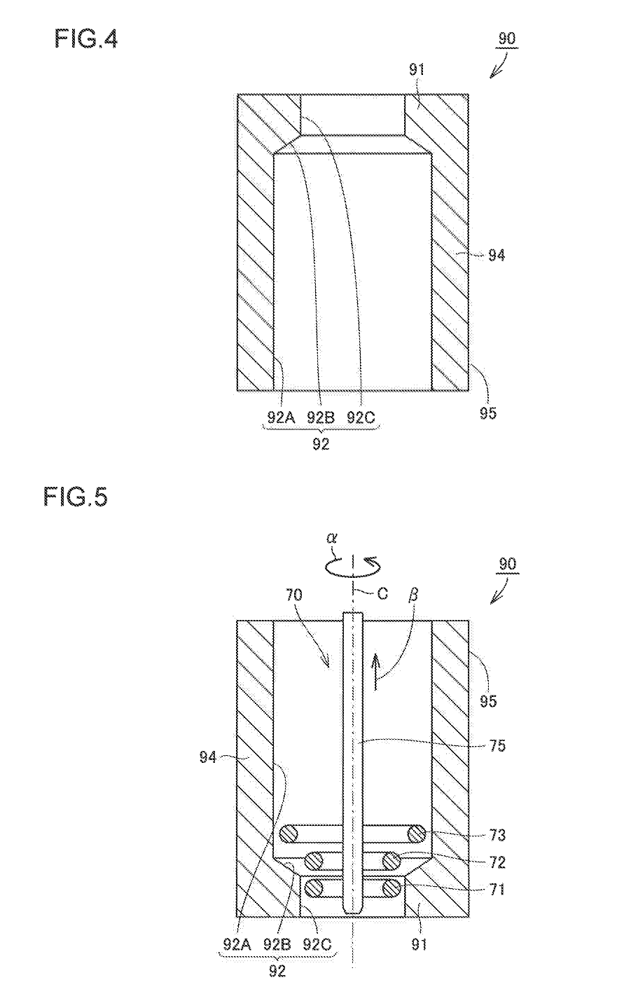

Next, a machining step is carried out as a step S20. In this step S20, the steel pipe prepared in the step S10 is subjected to cutting and/or other machining, whereby a formed body 90 having a shape approximating that of the inner-flanged bushing 60 in the present embodiment is obtained. FIG. 4 is a schematic cross-sectional view showing a structure of the formed body 90. Referring to FIGS. 4 and 2, the formed body 90 has an inner flange 91 and an inner peripheral surface 92 which correspond respectively to the inner flange 61 and the inner peripheral surface 62 of the inner-flanged bushing 60.

Next, an overall thermal refining step is carried out as a step S30. In this step S30, the formed body 90 obtained in the step S20 is subjected to thermal refining processing (quenching and tempering processing). Specifically, the formed body 90 is heated in a heating furnace to 860° C., for example, and then quenched, or, rapidly cooled from that temperature by immersion in oil. Thereafter, the formed body is heated in a heating furnace to 600° C., for example, and then cooled in air to room temperature. With this processing, the hardness of the formed body 90 is adjusted to 30 HRC or more and 45 HRC or less.

Next, an induction hardening step is carried out as a step S40. In this step S40, the formed body 90 having undergone the thermal refining processing in the step S30 is subjected to induction hardening processing. FIG. 5 is a schematic cross-sectional view illustrating the induction hardening step. Referring to FIG. 5, an induction hardening device 70 includes a first coil 71, a second coil 72, and a third coil 73, which are of a ring shape, and a support shaft 75. The first coil 71, the second coil 72, and the third coil 73 have their center on a central axis C of the support shaft 75, and are disposed side by side along the central axis C. The first coil 71, the second coil 72, and the third coil 73 are connected to and supported by the support shaft 75. The third coil 73 has a diameter larger than those of the first coil 71 and the second coil 72. The first coil 71 and the second coil 72 have an equal diameter. The first coil 71, the second coil 72, and the third coil 73 are arranged in this order from a side closer to one end of the support shaft 75. It should be noted that the applicable relationship in terms of size of the coils is not limited to the above; the diameters of the coils may be increased in the order of the first coil 71, the second coil 72, and the third coil 73.

In the step S40, a high-frequency current is supplied from a power source (not shown) to the first coil 71, the second coil 72, and the third coil 73 in the state where the first coil 71 and the second coil 72 face the inner peripheral surface 92 (tapered portion 92B and small-diameter portion 92C) of the inner flange 91 and the third coil 73 faces the inner peripheral surface 92 (large-diameter portion 92A) in the region other than the inner flange 91. This causes an eddy current to flow over the surface layer region of the inner peripheral surface 92 facing the first coil 71, the second coil 72, and the third coil 73, to thereby heat the region. The support shaft 75 moves along the central axis C in the direction indicated by the arrow β, while rotating about the central axis C in the direction indicated by the arrow α. Consequently, the region heated by the first coil 71, the second coil 72, and the third coil 73 move. Cooling water is sprayed onto the heated region, so that the region is cooled and quench hardened. In this manner, a quench hardened layer is formed (see the quench hardened layer 63 in FIG. 2). At this time, the thickness of the quench hardened layer can be adjusted by spraying cooling water onto an outer peripheral surface 95.

The quench hardened layer is made to have a thickness of, for example, not less than 3 mm and not more than 8 mm. In the region corresponding to the inner flange 91, the thickness of the quench hardened layer is made to take up, for example, not less than 10% and not more than 40% of the total thickness. The quench hardened layer is formed in such a manner that an interface between the quench hardened layer and a base region 94 as a region other than the quench hardened layer is positioned between the inner peripheral surface 92 and the outer peripheral surface 95 in the region corresponding to the inner flange 91 (see FIG. 2).

Next, a tempering step is carried out as a step S50. In this step S50, the formed body 90 with the quench hardened layer formed in the step S40 is subjected to low-temperature tempering. Specifically, the formed body 90 with the quench hardened layer formed is placed in a furnace and heated to, for example, 180° C., and then cooled in air. With this processing, the hardness of the quench hardened layer is adjusted to 55 HRC or more and 63 HRC or less.

Next, a finishing step is carried out as a step S60. In this step S60, the formed body 90 having undergone the tempering processing in the step S50 is subjected to cutting, polishing, and/or other finishing processing as necessary. Through the above procedure, the inner-flanged bushing 60 in the present embodiment is produced.

As described above, in the method for producing the inner-flanged bushing 60 in the present embodiment, a formed body 90 is prepared, which is made of a steel (steel for bushing) having the above-described appropriate component composition, has a shape corresponding to the inner-flanged bushing 60, and has a hardness of not less than 30 HRC and not more than 45 HRC. Thereafter, induction hardening processing is performed on the region including the inner peripheral surface 92 of the region including the inner flange 91, whereby a quench hardened layer 63 having a hardness of not less than 55 HRC and not more than 63 HRC is formed. With this configuration, the inner-flanged bushing 60 of the present embodiment can readily be produced.

### EXAMPLES

(Experiments Using Steel Pipes)

Steel pipes having the component compositions according to the present invention were prepared. Some of the pipes were subjected to heat treatment assuming a quench hardened layer (induction hardening, followed by tempering at 180° C.), and the other pipes were subjected to heat treatment assuming a base region (heating to 860° C. and oil quenching, followed by tempering at 600° C.), to prepare samples. Experiments were then conducted on the samples to examine their hardness and impact value. Each steel pipe had a hollow cylindrical shape with an outer diameter of 180 mm and an inner diameter of 146 mm. The hardness was measured using a Rockwell hardness tester. The impact value was measured by Charpy impact testing. The hardness after the heat treatment assuming a quench hardened layer is for evaluating wear resistance. The impact value after the heat treatment assuming a base region is for evaluating toughness. A test piece used for the impact test was of a quadrangular prism shape with a length of 55 mm, having a square-shaped end face with a side of 7.5 mm, and having a 2 mm-deep V notch formed at the center in the longitudinal direction.

For comparison, steel pipes made of JIS S55C, SUJ2, SNCM439, and SCM440 were prepared, and similar tests were performed on the samples. It should be noted that the samples made of JIS SNCM439 and SCM440 were subjected to overall quenching, followed by tempering at 200° C., as the heat treatment assuming a quench hardened layer. The component compositions of the respective samples are shown in Table 1, and the experimental results of the samples are shown in Table 2.

TABLE 1

| | C | Si | Mn | P | S | Ni | Cr | Mo | Note |
|---|---|---|---|---|---|---|---|---|---|
| No. 1 | 0.66 | 0.31 | 0.82 | 0.009 | 0.009 | 0.05 | 1.19 | 0.15 | Inventive Example |
| No. 2 | 0.57 | 0.24 | 0.57 | 0.010 | 0.006 | 0.02 | 0.48 | 0.47 | Inventive Example |
| No. 3 | 0.58 | 0.27 | 0.81 | 0.010 | 0.009 | 0.02 | 0.82 | 0.30 | Inventive Example |
| No. 4 | 0.55 | 0.25 | 0.80 | 0.017 | 0.014 | 0.04 | — | — | S55C |
| No. 5 | 1.08 | 0.25 | 0.40 | 0.015 | 0.013 | 0.02 | 1.50 | — | SUJ2 |
| | | | | | | | | | (Having Undergone |
| | | | | | | | | | Spheroidizing Heat |
| | | | | | | | | | Treatment) |
| No. 6 | 0.41 | 0.26 | 0.81 | 0.018 | 0.011 | 1.60 | 0.75 | 0.15 | SNCM439 |
| No. 7 | 0.41 | 0.25 | 0.80 | 0.016 | 0.013 | 0.03 | 0.75 | 0.15 | SCM440 |

TABLE 2

| | Assuming Quench Hardened Layer | | Assuming Base Region | | |
|---|---|---|---|---|---|
| | Impact Value (J/cm²) | Hardness (HRC) | Impact Value (J/cm²) | Hardness (HRC) | Note |
| No. 1 | 19 | 63 | 57 | 38 | Inventive Example |
| No. 2 | 34 | 60 | 70 | 37 | Inventive Example |
| No. 3 | 30 | 60 | 66 | 38 | Inventive Example |
| No. 4 | 11 | 56 | 48 | 33 | S55C |
| No. 5 | 8 | 63 | — | 20 | SUJ2 |
| | | | | | (Having Undergone |
| | | | | | Spheroidizing Heat |
| | | | | | Treatment) |
| No. 6 | 24 | 53 | — | — | SNCM439 |
| No. 7 | 11 | 54 | — | — | SCM440 |
| Acceptance | 18 or higher | 55-63 | 55 or higher | 30-40 | |
| Criteria | | | | | |

In Table 1, the numerical values are all in % by mass, and the remainder is composed of iron and unavoidable impurities. Phosphorus and sulfur, which are particularly important among the unavoidable impurities, are listed in the table. Nickel (Ni) included in the samples, except for the sample No. 6, is an unavoidable impurity. In Table 1, “-” means that it has not been added. In Table 2, “-” means that no relevant experiment has been conducted. Further, at the bottom of Table 2, numerical values (acceptance criteria) preferable for an inner-flanged bushing (bushing for a hydraulic breaker) are indicated.

Referring to Tables 1 and 2, the samples No. 4 to No. 7, each having the component composition falling outside the scope of the present invention, fail to simultaneously meet the acceptance criteria for the hardness after the heat treatment assuming a quench hardened layer and the impact value after the heat treatment assuming a base region, which are particularly important. In contrast, the samples No. 1 to No. 3 corresponding to the inventive examples meet the acceptance criteria for all the requirements. It is thus confirmed that the bushing for a hydraulic breaker ensuring both wear resistance and toughness can be produced using the steel having the component composition according to the present invention.

(Experiment Using Inner-flanged Bushings)

A steel having the component composition of No. 2 in Table 1 above was used to produce a sample having a shape corresponding to the inner-flanged bushing, and an experiment confirming the possibility of forming a hardened layer in a desired region was performed. Specifically, a steel pipe having the component composition of No. 2 was prepared and machined to obtain a formed body of a cylindrical shape with an outer diameter of 182 mm, an inner diameter of 145 mm, and an inner diameter at the inner flange of 124 mm. The steps S20 and S30 were carried out in a similar manner as in the above embodiment, and then an experiment of forming a quench hardened layer in a region including the inner peripheral surface was conducted using an induction hardening device 70 similar to that used in the above embodiment. As a result, a sample having the quench hardened layer formed in a desired region was produced successfully by adjusting the output and frequency of the high-frequency power supply, the moving velocity of the coils, and so on.

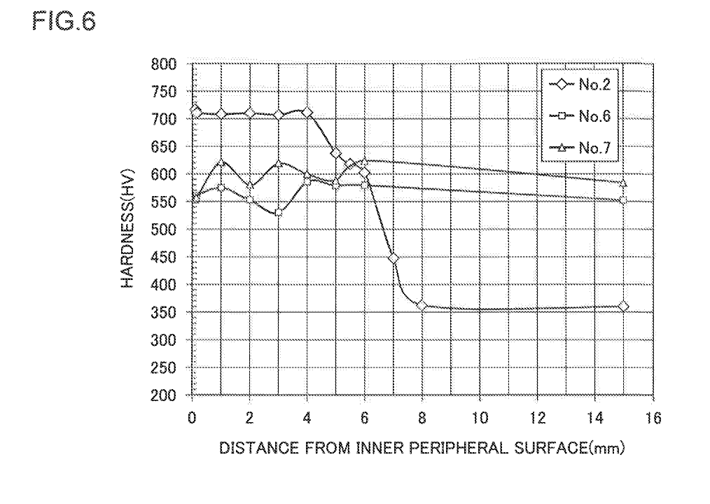

FIG. 6 shows hardness distribution in a thickness direction in the inner flange of the obtained sample. The horizontal axis represents distance from the inner peripheral surface, and the vertical axis represents hardness. For comparison, FIG. 6 also shows hardness distribution in samples of a similar shape, which have been made of steels of No. 6 and No. 7 in Table 1 and have undergone overall quenching.

Referring to FIG. 6, the samples No. 6 and No. 7 as the comparative examples have their hardness approximately uniform from the inner peripheral surface toward the inside. In contrast, the sample No. 2 as the inventive example has a quench hardened layer of a sufficient hardness formed by a sufficient thickness in the region including the inner peripheral surface, and it has a low hardness in the inside. With such hardness distribution, it is confirmed that according to the inner-flanged bushing (bushing for a hydraulic breaker) in the present invention, wear resistance is ensured by the quench hardened layer which is high in hardness and, at the same time, high toughness is obtained by the inner portion (base region) which is low in hardness.

It should be understood that the embodiment and examples disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The bushing for a hydraulic breaker and its producing method according to the present invention are applicable particularly advantageously to a bushing for a hydraulic breaker for which high durability is required.

### DESCRIPTION OF REFERENCE NUMERALS

1: hydraulic breaker; 10: chisel; 11: distal narrowing portion; 11A: distal end; 12: base portion; 12A: proximal end; 12B: proximal narrowing portion; 12C: proximal cylindrical portion; 20: piston; 21: distal flat portion; 30: frame; 31: impact chamber; 32: oil chamber; 40: control valve mechanism; 50: outer-flanged bushing; 60: inner-flanged bushing; 61: inner flange; 62: inner peripheral surface; 62A: large-diameter portion; 62B: tapered portion; 62C: small-diameter portion; 63: quench hardened layer; 64: base region; 65: outer peripheral surface; 66, 67: end face; 70: induction hardening device; 71: first coil; 72: second coil; 73: third coil; 75: support shaft; 90: formed body; 91: inner flange; 92: inner peripheral surface; 92A: large-diameter portion; 92B: tapered portion; 92C: small-diameter portion; 94: base region; and 95: outer peripheral surface.

1-11. (canceled)

12. A bushing for a hydraulic breaker, the bushing being of a tubular shape having an inner flange protruding radially toward a center from an inner periphery in a region including an axial end, the bushing being made of a steel containing not less than 0.55% by mass and not more than 0.70% by mass of carbon, not less than 0.15% by mass and not more than 0.35% by mass of silicon, not less than 0.4% by mass and not more than 0.9% by mass of manganese, not less than 0.4% by mass and not more than 1.3% by mass of chromium, and not less than 0.10% by mass and not more than 0.55% by mass of molybdenum, with the balance being iron and unavoidable impurities, the bushing comprising:
a base region having a hardness of not less than 30 HRC and not more than 45 HRC; and
a quench hardened layer formed on an inner periphery side of the base region so as to include an inner peripheral surface of a region including the inner flange, the quench hardened layer having a hardness of not less than 55 HRC and not more than 63 HRC.

13. The bushing for a hydraulic breaker according to claim 12, wherein phosphorus and sulfur among the unavoidable impurities in the steel are contained respectively in an amount of not more than 0.015% by mass.

14. The bushing for a hydraulic breaker according to claim 12, wherein the quench hardened layer has a thickness of not less than 3 mm and not more than 8 mm.

15. The bushing for a hydraulic breaker according to claim 13, wherein the quench hardened layer has a thickness of not less than 3 mm and not more than 8 mm.

16. The bushing for a hydraulic breaker according to claim 12, wherein the quench hardened layer has a thickness that takes up not less than 10% and not more than 40% of a total thickness in a region corresponding to the inner flange.

17. The bushing for a hydraulic breaker according to claim 13, wherein the quench hardened layer has a thickness that takes up not less than 10% and not more than 40% of a total thickness in a region corresponding to the inner flange.

18. The bushing for a hydraulic breaker according to claim 14, wherein the quench hardened layer has a thickness that takes up not less than 10% and not more than 40% of a total thickness in a region corresponding to the inner flange.

19. The bushing for a hydraulic breaker according to claim 15, wherein the quench hardened layer has a thickness that takes up not less than 10% and not more than 40% of a total thickness in a region corresponding to the inner flange.

20. The bushing for a hydraulic breaker according to claim 12, wherein a region corresponding to the inner flange has an inner peripheral surface included in the quench hardened layer and an outer peripheral surface included in the base region.

21. The bushing for a hydraulic breaker according to claim 12, wherein an end face on a side where the inner flange is located includes the quench hardened layer on an inner peripheral surface side and the base region on an outer peripheral surface side.

22. A method for producing a bushing for a hydraulic breaker, comprising the steps of:
preparing a formed body of a tubular shape having an inner flange protruding radially toward a center from an inner periphery in a region including an axial end, the formed body being made of a steel containing not less than 0.55% by mass and not more than 0.70% by mass of carbon, not less than 0.15% by mass and not more than 0.35% by mass of silicon, not less than 0.4% by mass and not more than 0.9% by mass of manganese, not less than 0.4% by mass and not more than 1.3% by mass of chromium, and not less than 0.10% by mass and not more than 0.55% by mass of molybdenum, with the balance being iron and unavoidable impurities, the formed body having a hardness of not less than 30 HRC and not more than 45 HRC; and
forming a quench hardened layer by performing induction hardening processing on a region including an inner peripheral surface of a region including the inner flange of the formed body, the quench hardened layer having a hardness of not less than 55 HRC and not more than 63 HRC.

23. The method for producing the bushing for a hydraulic breaker according to claim 22, wherein phosphorus and sulfur among the unavoidable impurities in the steel are contained respectively in an amount of not more than 0.015% by mass.

24. The method for producing the bushing for a hydraulic breaker according to claim 22, wherein in the step of forming the quench hardened layer, the quench hardened layer having a thickness of not less than 3 mm and not more than 8 mm is formed.

25. The method for producing the bushing for a hydraulic breaker according to claim 23, wherein in the step of forming the quench hardened layer, the quench hardened layer having a thickness of not less than 3 mm and not more than 8 mm is formed.

26. The method for producing the bushing for a hydraulic breaker according to claim 22, wherein in the step of forming the quench hardened layer, the quench hardened layer is formed so as to have a thickness that takes up not less than 10% and not more than 40% of a total thickness in a region corresponding to the inner flange.

27. The method for producing the bushing for a hydraulic breaker according to claim 23, wherein in the step of forming the quench hardened layer, the quench hardened layer is formed so as to have a thickness that takes up not less than 10% and not more than 40% of a total thickness in a region corresponding to the inner flange.

28. The method for producing the bushing for a hydraulic breaker according to claim 24, wherein in the step of forming the quench hardened layer, the quench hardened layer is formed so as to have a thickness that takes up not less than 10% and not more than 40% of a total thickness in a region corresponding to the inner flange.

29. The method for producing the bushing for a hydraulic breaker according to claim 25, wherein in the step of forming the quench hardened layer, the quench hardened layer is formed so as to have a thickness that takes up not less than 10% and not more than 40% of a total thickness in a region corresponding to the inner flange.

30. The method for producing the bushing for a hydraulic breaker according to claim 22, wherein in the step of forming the quench hardened layer, the quench hardened layer is formed in such a manner that an interface between the quench hardened layer and a base region as a region other than the quench hardened layer is located between an inner peripheral surface and an outer peripheral surface of a region corresponding to the inner flange.
